(19) United States
(12) Patent Application Publication
(10) Pub. No.: US 2002/0162986 A1
(43) Pub. Date: Nov. 7, 2002

(54) Ball valve with integral purge port

(76) Inventor: John Rocheleau, Concord, NH (US)

Correspondence Address: G. ROGER LEE, Fish & Richardson P.C., 225 Franklin Street, Boston, MA, 02110-2804, US

(21) Appl. No.: 09/849,847

(22) Filed: May 4, 2001

(51) Int. Cl. F16K 5/06

(52) U.S. Cl. 251/315.1

(57) ABSTRACT

A ball valve for a hydronic heating or cooling system, in which a purge port is integral with the valve body of the ball valve. The valve body that has an inlet and outlet port, and an interior passage configured to permit liquid to flow between the inlet and outlet ports. A ball element is supported within the valve body, the ball element having a flow passage extending there through, and the ball element being supported so that it can rotate from one position in which the liquid is able to flow through the flow passage, to a second position in which the liquid is unable to flow through the flow passage. An actuating shaft extends from the ball element through a first opening in the valve body to the exterior of the valve body. A handle connects to the actuating shaft for rotating the shaft and ball element. A purge element is integral with the valve body, the purge element including a purge port communicating with the interior passage of the valve body at a location between the ball element and one of the inlet and outlet ports, and the purge port being threaded to accept a threaded male fitting. An integral flange element may be configured to connect the valve to a hydronic circulator.

### TECHNICAL FIELD

This invention relates to hydronic heating systems, and more particularly to ball valves for such systems.

### BACKGROUND

Hydronic heating systems often include a hydronic circulator that circulates water through a furnace (or cooling heat exchanger) and through pipes connecting the furnace to radiators or heat exchangers in the heated (or cooled) space. A ball valve is typically installed in the pipe adjacent to the circulator (e.g., by sweating the copper pipe at both ends of the valve). The circulator is connected to the pipe using a flange element, which is normally separately connected to the pipe. The ball valve is typically used to isolate the length of pipe constituting a heating (or cooling) zone.

Another fitting commonly found in a hydronic heating system is a purge port fitting. This fitting is typically installed in the pipe through which hydronic system liquid is circulated, in order to allow liquid to be purged from the system. The purge port typically has a ½-inch female NPT thread that can receive a standard stop valve, which is opened for purging. Typically, the purge port is aligned perpendicularly to the flow through the pipe. The port is also used for attaching diagnostic apparatus such as pressure or temperature sensors, or for connecting control devices of one type or another.

### SUMMARY

The invention features a hydronic heating (or cooling) system ball valve with an integral purge port. By integrating the ball valve and purge port in the same unit, the installer needs to install only one item, versus separate ball valve and purge port fittings, as heretofore required. Where the two components are installed adjacent one another, the installer is also saved the trouble of cutting and installing a length of pipe connecting the two. From the manufacturer's perspective, there is now one part instead of two, making it possible to lower overall manufacturing cost.

In general, the invention features a ball valve for a hydronic heating or cooling system, including a valve body that has an inlet and outlet port, and an interior passage configured to permit liquid to flow between the inlet and outlet ports; a ball element supported within the valve body, the ball element having a flow passage extending there through, and the ball element being supported so that it can rotate from one position in which the liquid is able to flow through the flow passage, to a second position in which the liquid is unable to flow through the flow passage; an actuating shaft extending from the ball element through a first opening in the valve body to the exterior of the valve body; a handle connected to the actuating shaft for rotating the shaft and ball element; a purge element integral with the valve body, the purge element comprising a purge port communicating with the interior passage of the valve body at a location between the ball element and one of the inlet and outlet ports, and the purge port being configured to accept a threaded male fitting.

In preferred implementations, one or more of the following features may be incorporated. The ball valve may be integral with a flange element configured for making a connection to a hydronic circulator; by integrating the ball valve with the flange element, the installer needs to install only one item, versus separate ball valve and flange fittings. The flange element may be allowed to rotate relative to the valve body during assembly to allow the installer to select a preferred orientation. Alternatively, the flange element may be unitary with the valve body (e.g., portions of the same brass casting or forging). The purge element may be a unitary portion of the valve body (e.g., a portion of the same brass casting or forging), and the purge port an opening in the valve body. The ball element may be a chrome-plated solid ball. At least one of the inlet and outlet ports may be sized and configured to make a sweat connection to a copper pipe. At least one of the inlet and outlet ports may be sized and configured to make a threaded connection to a pipe. The purge port may be oriented at approximately 90 degrees from the orientation of the actuating shaft for the ball valve. The flange element may be connected to the valve body by a threaded member that engages a threaded interior surface of the valve body. Alternatively, the flange element, itself, is threaded and engages a threaded interior surface of the valve body. A resilient sealing member may be captured between the threaded member and a seal that engages the ball element. There may be at least one ring seal providing a seal between the surface of the ball element and the interior of the valve body.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is an elevation view taken along 1-1 in FIG. 3 of a valve body of an embodiment of the invention in which the valve body, flange, and purge port are unitary.

FIG. 2 is a cross-sectional view taken along 2-2 in FIG. 3 of the valve body of FIG. 1.

FIG. 3 is an elevation view taken along 3-3 in FIG. 1 of the valve body of FIG. 1.

FIG. 4 is an elevation view taken along 4-4 in FIG. 3 of the valve body of FIG. 1.

FIG. 5 is a cross-sectional view taken along 5-5 in FIG. 4 of the valve body of FIG. 1.

FIG. 6 is an exploded perspective view of a preferred embodiment of the invention in which the purge port and valve body are unitary, and the flange is integral with the valve body.

FIG. 7 is an exploded perspective view of a third embodiment of the invention, in which the ball valve does not have an integral flange element.

FIGS. 8 and 9 are elevation and plan views of an alternative embodiment of a threaded flange element that can be threaded into mating threads in the valve body.

### DETAILED DESCRIPTION

FIG. 6 shows a preferred embodiment of the invention. Ball valve 8 has a brass valve body 10 (brass casting or forging) with ball 12, actuating shaft 14, Teflon seals 20, 22, purge port 38, and flange element 28. Liquid normally flow from inlet port 24 to outlet port 26, but the valve can also be operated in the reverse orientation. The inlet port 24 is configured to make a sweat connection to a copper pipe (not shown). The outlet port 26 is located in flange element 28, which is sized and configured for installation directly onto a hydronic circulator (not shown). Two holes 30 in the flange element receive bolts for connecting the valve to the circulator. A gasket (not shown) of approximately the same shape as the flange surface seals the flange element to the circulator. Flange element 28 is installed by threading member 16 (brass) into female threads 17 in valve body 10. Ball 12 and seals 20, 22 are installed prior to installation of the flange element. O-ring 18 is installed between the interior surface of member 16 and Teflon seal 22, to provide advantageous resiliency for the seal between ball 10 and seal 22. During installation of the ball valve, the relative angular orientation of the flange element 28 and the valve body 10 can be adjusted. Once the desired orientation is chosen, bolts (not shown) extending through holes 30 into the circulator are tightened to retain the orientation.

FIGS. 8 and 9 show an alternative to using a separate threaded member 16 to install the flange element 28. Threads 80 on the flange element are threaded into female threads 17 in the valve body 10. Adjustment of the relative angular orientation of the flange element and the valve body can still be provided. The design has the advantage that the same valve body can be used with or without the flange element, thereby obviating the need to manufacture and stock two different valve bodies.

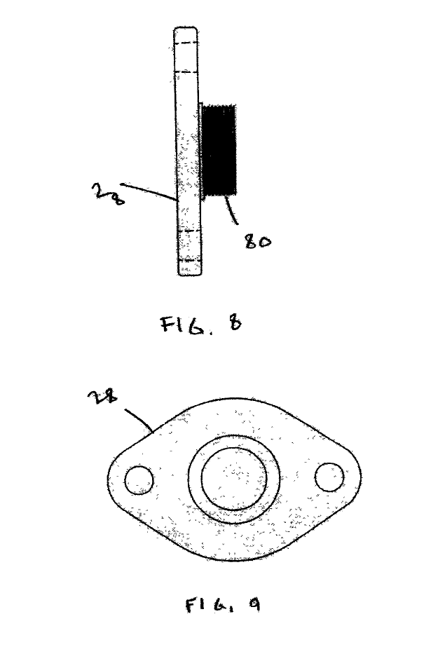

Ball 12 is supported within cavity 32 (FIG. 2) of the valve body 10, and sealed to the interior surface of cavity 32 by Teflon seals 20, 22. Actuating shaft 14 is connected to the ball 12 by a ridge 35 that extends into a slot 34 in the ball 12. The shaft extends outwardly from the ball through an opening 36. The shaft is installed by inserting it from the interior of the valve body outwardly through opening 36. Two O-rings 38 fit into grooves 39 to seal the actuating shaft 14 within opening 36. Ball 12 and seals 20, 22 are installed through the inlet port 26 during assembly. Handle (lever) 40 is attached to the end of actuating shaft 14 with nut 50. A projection 42 on the end of the handle engages stop surfaces 44 formed on the outside surface of the valve body, to restrain movement of the actuating shaft through 90 degrees of travel. In one extreme position of the handle, passage 46 through ball 12 is aligned with the flow path through the valve, to allow flow from the inlet to the outlet port (or vice versa). In the second extreme position, 90 degrees of rotation from the first extreme position, passage 46 is aligned at 90 degrees to the flow direction through the valve, preventing any flow through the valve (the ball is shown in that position in FIGS. 6-7).

A purge port 38 is an integral part of valve body 10 (the port is unitary with the valve body in this embodiment). The port 38 is a female threaded opening (½-inch NPT) configured to accept a standard stop valve, which can be opened for purging a hydronic heating (or cooling) system. The purge port is aligned perpendicularly to flow through the valve body (i.e., the axis of the purge port is perpendicular to the axis of the interior passage connecting the inlet and outlet ports). The purge port may also be used for attaching diagnostic apparatus such as pressure or temperature sensors, or for connecting control devices to the hydronic system.

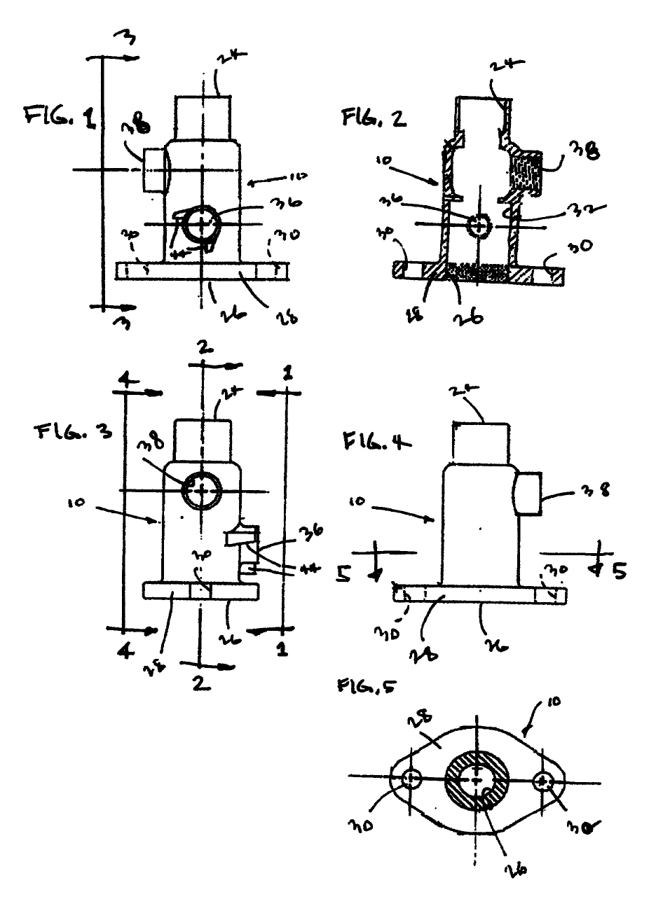

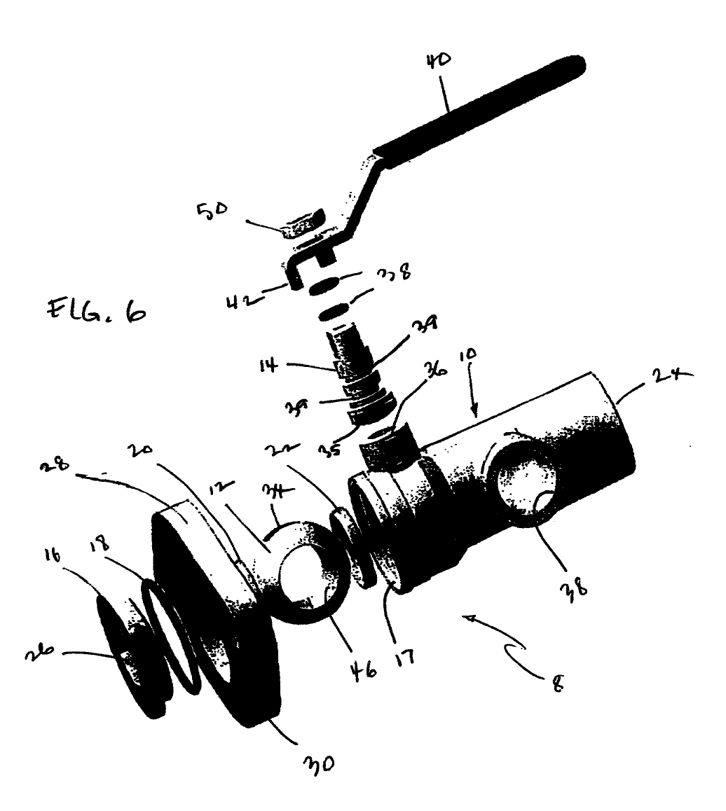

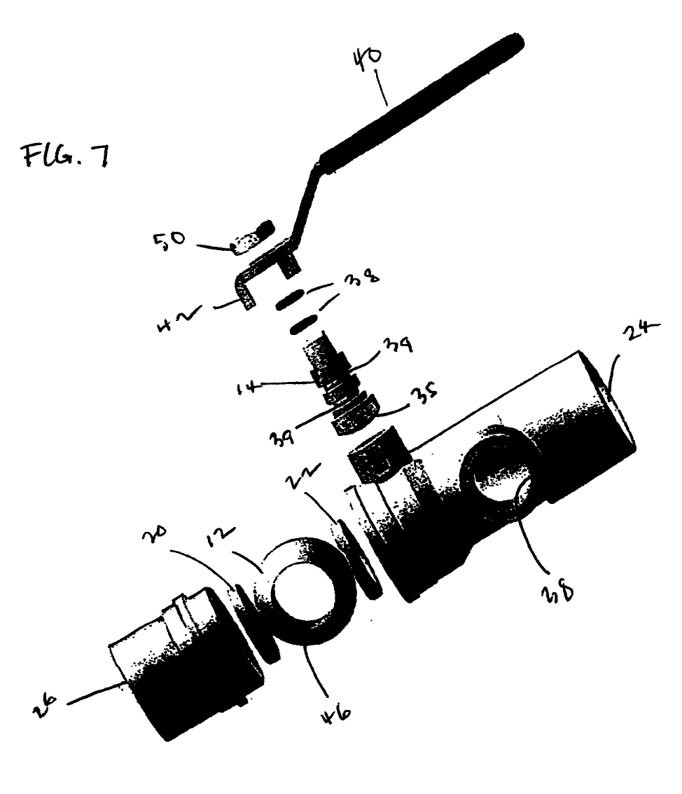

FIGS. 1-5 show a slightly different embodiment from that shown in FIG. 6. The embodiment differs in that the flange element 28 is unitary (portion of the same casting or forging) rather than just integral with the valve body.

FIG. 7 shows an alternative embodiment in which the flanged outlet port of FIG. 6 has been replaced with an outlet port configured for making a sweat connection to a copper pipe. Alternatively, one or both of the inlet and outlet ports, could be configured for connecting to a threaded (e.g., NPT) pipe or pipe fitting.

A number of embodiments of the invention have been described. Nevertheless, it will be understood that various modifications may be made without departing from the spirit and scope of the invention. For example, a threaded (e.g., NPT) connection could replace one or both of the sweated connections shown in the figures. The flange and/or purge port could be formed from a separate piece of metal that is permanently attached to the valve body of the ball valve, to make the flange and/or purge port “integral” with the valve body. Alternatively, the flange and/or purge port could be formed from the same piece of metal as the valve body, to make the flange and/or purge port “unitary” with the valve body. Many other embodiments are within the scope of the following claims.

What is claimed is:

1. A ball valve for a hydronic heating or cooling system, comprising:.
a valve body with an inlet and outlet port, and with an interior passage configured to permit liquid to flow between the inlet and outlet ports;
a ball element supported within the valve body, the ball element having a flow passage extending there through, and the ball element being supported so that it can rotate from one position in which the liquid is able to flow through the flow passage, to a second position in which the liquid is unable to flow through the flow passage;
an actuating shaft extending from the ball element through a first opening in the valve body to the exterior of the valve body;
a handle connected to the actuating shaft for rotating the shaft and ball element;
a purge element integral with the valve body, the purge element comprising a purge port communicating with the interior passage of the valve body at a location between the ball element and one of the inlet and outlet ports, and the purge port being threaded to accept a threaded male fitting.

2. The ball valve of claim 1 further comprising a flange element at one of the inlet and outlet ports, the flange element being configured to be directly mounted to the flange of a hydronic circulator.

3. The ball valve of claim 1 or 2 wherein the purge element is a unitary portion of the valve body, and the purge port is an opening in the valve body.

4. The ball valve of claim 3 wherein the valve body and the unitary purge element are portions of the same brass body.

5. The ball valve of claim 4 wherein the ball element is a chrome-plated solid ball.

6. The ball valve of claim 2 wherein the flange element is unitary with the valve body.

7. The ball valve of claim 1 or 2 wherein at least one of the inlet and outlet ports is sized and configured to make a sweat connection to a copper pipe.

8. The ball valve of claim 1 or 2 wherein at least one of the inlet and outlet ports is sized and configured to make a threaded connection to a pipe.

9. The ball valve of claim 1 or 2 wherein the purge port is oriented at 90 degrees from the orientation of the actuating shaft for the ball valve.

10. The ball valve of claim 2 wherein the flange element is connected to the valve body by a threaded member that engages a threaded interior surface of the valve body.

11. The ball valve of claim 2 wherein the flange element is threaded and engages a threaded interior surface of the valve body.

12. The ball valve of claim 10 wherein a resilient sealing member is captured between the threaded member and a seal that engages the ball element.

13. The ball valve of claim 11 wherein a resilient sealing member is captured between the threaded flange element and a seal that engages the ball element.

14. The ball valve of claim 1 or 2 wherein there is at least one ring seal providing a seal between the ball element and the interior of the valve body.
